(19) United States
(12) Patent Application Publication
(10) Pub. No.: US 2026/0291224 A1
(43) Pub. Date: Sep. 24, 2026

(54) SYSTEM AND METHOD FOR VEHICLE BATTERY JUMP STARTER

(71) Applicant: MILWAUKEE ELECTRIC TOOL CORPORATION, Brookfield, WI (US)

(72) Inventors: Max D. Mutza, Menomonee Falls, WI (US); Julio C. Puentes Flores, Milwaukee, WI (US); Zichen Tan, Oak Creek, WI (US); Christopher F. Boehme, Sussex, WI (US); Steven K. Hansen, Port Washington, WI (US)

(21) Appl. No.: 19/572,653

(22) Filed: Mar. 19, 2026

Related U.S. Application Data
(60) Provisional application No. 63/775,819, filed on Mar. 21, 2025.

(51) Int. Cl. H02J 1/10; H01M 10/42; H01M 10/48; H01M 50/247; H02J 7/34; H02J 7/50; H02J 7/70; H02J 7/80; H02J 7/96; B60R 16/033

(52) U.S. Cl. CPC H02J 1/122; H01M 10/4264; H01M 10/486; H01M 50/247; H02J 7/345; H02J 7/575; H02J 7/751; H02J 7/80; H02J 7/96; B60R 16/033; H01M 2220/30; H02J 2207/50

(57) ABSTRACT

A system may include a battery pack interface configured to receive a removable and rechargeable battery pack. A system may include a power boost module including a plurality of supercapacitor banks, each supercapacitor bank comprising a plurality of supercapacitors, the power boost module configured to be charged via the battery pack interface from the removable and rechargeable battery pack. A system may include a controller including an electronic processor configured to: selectively charge the plurality of supercapacitors to predetermined voltage levels, combine a selection of supercapacitor banks in series to produce a final output voltage that exceeds the voltage of the battery pack, and control a discharge current from the series-combined supercapacitor banks to deliver a jump start current to a vehicle battery.

### CROSS-REFERENCE TO RELATED APPLICATIONS

This application claims priority to, and the benefit of, U.S. Provisional Patent Application Serial No. 63/775,819, filed Mar. 21, 2025, the entire contents of which is hereby incorporated by reference.

### BACKGROUND

The present invention relates to a vehicle battery jump starter powered by a removable and rechargeable battery pack.

### SUMMARY

Vehicle battery jump starters are constrained by several power source limitations that complicate their design and implementation. In particular, the internal power supply must be engineered to handle both overvoltage conditions from the vehicle battery and undervoltage scenarios within the jump starter unit itself. Additionally, these devices require robust safeguards against transient events such as sparking and short circuits, while also ensuring precise control of high electrical current flows. Consequently, jump starters are typically developed as dedicated, self-contained systems with integrated power sources that can be recharged and deployed as needed. Common configurations include sealed lead acid batteries, assemblies of lithium polymer cells, or composite battery packs.

One of the challenges in developing a vehicle battery jump starter that relies on a removable battery pack is the inherent voltage limitation of the battery pack itself. This limitation can be addressed by employing a two-stage power conversion approach wherein the battery pack initially charges a bank of high-rate supercapacitors or additional lithium polymer cells. Once charged, these components can deliver the necessary high current pulses to initiate the vehicle battery. However, the peak voltage and current demands required for a successful jump start may still exceed the output capabilities of the battery pack. Accordingly, the systems and methods disclosed herein focus on strategies to enhance the available power of a vehicle battery jump start device, ensuring reliable performance across a range of vehicle battery conditions and sizes.

In some aspects, the techniques described herein relate to a vehicle battery jump starter device including a battery pack interface configured to receive a removable and rechargeable battery pack. The system further includes a power boost module including a plurality of supercapacitor banks, each supercapacitor bank including a plurality of supercapacitors, the power boost module configured to be charged via the battery pack interface from the removable and rechargeable battery pack. The system further includes a controller including an electronic processor configured to selectively charge the plurality of supercapacitors to predetermined voltage levels, combine a selection of supercapacitor banks in series to produce a final output voltage that exceeds the voltage of the battery pack, and control a discharge current from the series-combined supercapacitor banks to deliver a jump start current to a vehicle battery.

In some aspects, the techniques described herein relate to a vehicle battery jump starter device, further including a user selectable input configured to enable a user to select a desired final output voltage level.

In some aspects, the techniques described herein relate to a vehicle battery jump starter device, wherein the battery pack interface includes a plurality of electrical terminals configured to couple mechanically and electrically with the removable and rechargeable battery pack.

In some aspects, the techniques described herein relate to a vehicle battery jump starter device, further including one or more relays operatively coupled to the controller and configured to selectively configure the plurality of supercapacitors into the supercapacitor banks.

In some aspects, the techniques described herein relate to a vehicle battery jump starter device, wherein the controller is further configured to automatically determine a configuration of the supercapacitor banks based on one or more parameters of a connected vehicle battery and combine the selected charged supercapacitor banks in series to produce the final output voltage.

In some aspects, the techniques described herein relate to a vehicle battery jump starter device, wherein the controller is further configured to monitor at least one condition of the removable and rechargeable battery pack, the condition including at least one of a voltage, a temperature, or an impedance, and to adjust the charging of the supercapacitors based upon the at least one condition.

In some aspects, the techniques described herein relate to a vehicle battery jump starter device, wherein the power boost module includes a first plurality of supercapacitors combined in series to form a first supercapacitor bank, and a second plurality of supercapacitors combined in series to form a second supercapacitor bank, wherein the first and second supercapacitor banks are further connected in series, by the controller, to generate the final output voltage.

In some aspects, the techniques described herein relate to a vehicle battery jump starter device, wherein the final output voltage produced by the series-combined supercapacitor banks exceeds the voltage of the battery pack by a factor of at least 1.5.

In some aspects, the techniques described herein relate to a vehicle battery jump starter device, further including a FET switching module operatively coupled to the controller and configured to control both charging and discharging operations of the plurality of supercapacitor banks.

In some aspects, the techniques described herein relate to a vehicle battery jump starter device, further including a communication interface configured to transmit battery-specific information between the removable and rechargeable battery pack and the controller.

In some aspects, the techniques described herein relate to a vehicle battery jump starter device, wherein the controller further includes a memory for storing historical performance data of the removable and rechargeable battery pack, and wherein the stored historical performance data is used to adjust charging and discharge parameters of the power boost module.

In some aspects, the techniques described herein relate to a vehicle battery jump starter device including a battery pack interface configured to receive a removable and rechargeable battery pack, the removable and rechargeable battery pack having a voltage, a power boost module including a plurality of supercapacitors. The system further includes a controller including an electronic processor configured to charge the plurality of supercapacitors from energy provided from the removable and rechargeable battery pack, configure a first selection of the plurality of supercapacitors into a first supercapacitor bank, the first supercapacitor bank configured to be charged to a predetermined voltage level that is less than the voltage of the battery pack, and configure a second selection of the plurality of supercapacitors into a second supercapacitor bank, the second supercapacitor bank configured to be charged to a predetermined voltage level that is less than the voltage of the battery pack and less than the voltage of the first supercapacitor bank. The electronic processor is further configured to combine the first supercapacitor bank and the second supercapacitor bank in series to produce a final output voltage, the final output voltage being greater than the voltage of the removable and rechargeable battery pack, and control a discharge current from the series-combined supercapacitor banks to deliver a jump start current to a vehicle battery.

In some aspects, the techniques described herein relate to a vehicle battery jump starter device, further including a user selectable input device configured to enable a user to select a desired final output voltage prior to the configuration of the first and second supercapacitor banks.

In some aspects, the techniques described herein relate to a vehicle battery jump starter device, wherein the controller is further configured to monitor the voltage of the removable and rechargeable battery pack and adjust the charging of the plurality of supercapacitors based on the monitored voltage.

In some aspects, the techniques described herein relate to a vehicle battery jump starter device, further including one or more relays operatively coupled to the controller and configured to selectively connect the plurality of supercapacitors to the removable and rechargeable battery pack.

In some aspects, the techniques described herein relate to a vehicle battery jump starter device, wherein the controller is further configured to automatically determine a number of supercapacitors in the plurality of supercapacitors to include in the first supercapacitor bank and the second supercapacitor bank based on a measured voltage of a connected vehicle battery.

In some aspects, the techniques described herein relate to a method for operating a vehicle battery jump starter device, the method including attaching a removable and rechargeable battery pack, the battery pack having a voltage, to the vehicle battery jump starter device via a battery pack interface, and selecting a required final output voltage level for the vehicle battery jump starter device. The method further includes connecting a power boost module, the power boost module including a plurality of supercapacitors, to the battery pack for charging the plurality of supercapacitors from energy provided by the battery pack. The method further includes determining, via a controller including an electronic processor, a configuration of supercapacitor banks by connecting a first selection of the plurality of supercapacitors into a first supercapacitor bank configured to be charged to a predetermined voltage level that is less than the voltage of the battery pack, and connecting a second selection of the plurality of supercapacitors into a second supercapacitor bank configured to be charged to a predetermined voltage level that is less than both the voltage of the battery pack and the voltage of the first supercapacitor bank, charging and connecting the plurality of supercapacitors into the determined configuration of the first and second supercapacitor banks, combining the first and second supercapacitor banks in series to produce a final output voltage that exceeds the voltage of the removable and rechargeable battery pack, and controlling a discharge current from the series-combined supercapacitor banks to deliver a jump start current to a vehicle battery.

In some aspects, the techniques described herein relate to a method, further including receiving a user input via a user selectable input device to determine the required final output voltage level.

In some aspects, the techniques described herein relate to a method, further including monitoring at least one parameter of the removable and rechargeable battery pack, the parameter selected from the group consisting of voltage, temperature, and impedance, and adjusting the charging of the plurality of supercapacitors based on the monitored parameter.

In some aspects, the techniques described herein relate to a method, further including automatically determining, via the controller, a configuration of the plurality of supercapacitors into the first and second supercapacitor banks based on battery-specific information of the removable and rechargeable battery pack.

Before any embodiments of the invention are explained in detail, it is to be understood that the invention is not limited in its application to the details of the configuration and arrangement of components set forth in the following description or illustrated in the accompanying drawings. The invention is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components may be utilized to implement the invention. For example, “servers” and “computing devices” described in the specification can include one or more processing units, one or more computer-readable medium modules, one or more input/output interfaces, and various connections (e.g., a system bus) connecting the components.

Other aspects of the invention will become apparent by consideration of the detailed description and accompanying drawings.

### BRIEF DESCRIPTION OF THE DRAWINGS

FIG. 1A is a perspective view of a battery pack, according to an embodiment of the invention.

FIG. 1B is an alternative view of the battery pack of FIG. 1B.

FIG. 2 is an electromechanical diagram of the battery pack of FIG. 1A-1B, according to an embodiment of the invention.

FIG. 3 illustrates a vehicle battery jump starter configured to receive, support, and be powered by the battery pack of FIG. 1A-1B, according to an embodiment of the invention.

FIG. 4 is an electromechanical diagram of the vehicle battery jump starter of FIG. 3, according to an embodiment of the invention.

FIG. 5A-5C is an electromechanical diagram of supercapacitor banks of the vehicle battery jump starter, according to an embodiment of the invention.

FIG. 6A-6C is an electromechanical diagram of supercapacitor banks of the vehicle battery jump starter, according to an embodiment of the invention.

FIG. 7 is a process for jump starting a vehicle battery using the vehicle battery jump starter, according to an embodiment of the invention.

### DETAILED DESCRIPTION

This invention relates to a vehicle battery jump starter that is powered by a removable and rechargeable battery pack, such as a battery pack used with various hand-held power tools. The battery pack removably connects to a vehicle battery jump starter. The battery pack, or a plurality of battery packs connected together, can be used to power the vehicle battery jump starter and jump start a vehicle battery. The battery pack can also be selectively used to charge a power boost module within the vehicle battery jump starter. The power boost module includes, for example, a plurality of supercapacitors or lithium polymer battery cells. In some examples, the supercapacitors are organized into multiple supercapacitor banks which may be charged to different voltage levels by the jump starter. The multiple supercapacitor banks may then be combined in series (e.g., series-combined) to achieve a desired total output voltage level. The power boost is then used to discharge a jump start current from the multiple supercapacitor banks to jump start a vehicle battery.

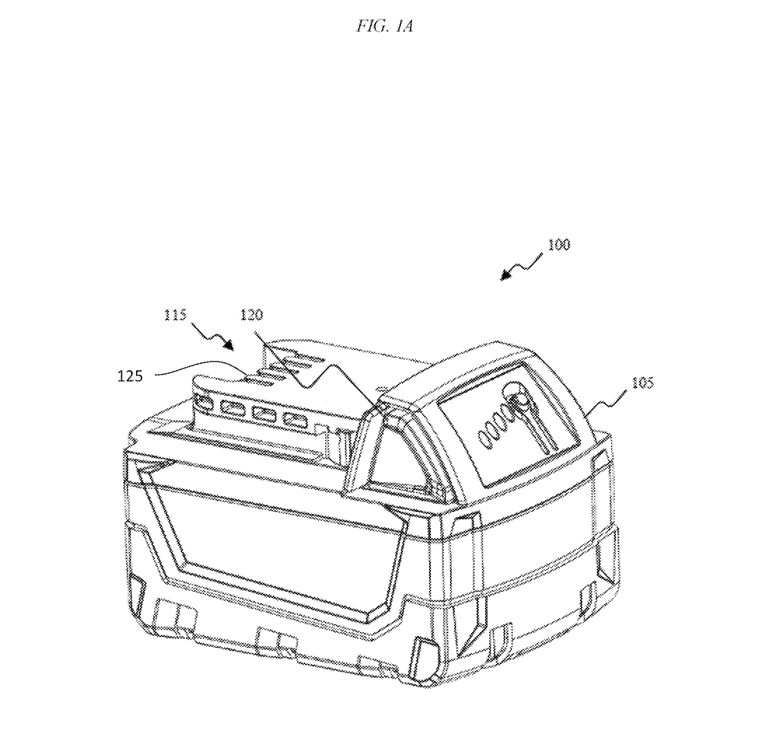

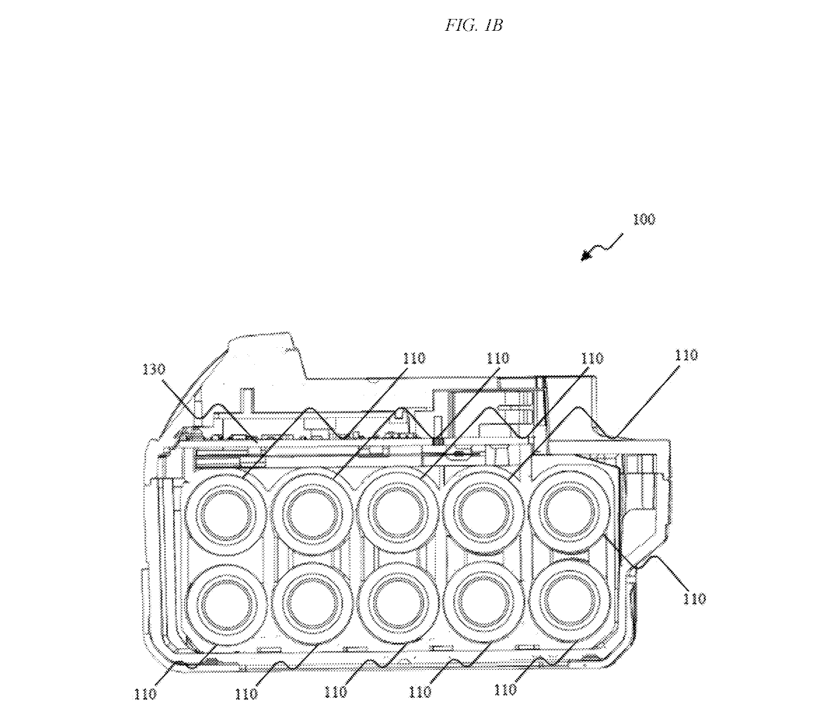

FIGS. 1A-1B illustrate a battery pack 100 for use with a vehicle battery jump starter, also referred to as a battery pack powered vehicle battery jump starter system. The battery pack 100 is connectable to and supportable by hand-held power tools such as drills, fasteners, saws, pipe cutters, sanders, nailers, staplers, vacuum cleaners, etc. The battery pack 100 is also connectable to and supportable by outdoor power tools such as string trimmers, hedge trimmers, blowers, chain saws, etc. As shown in FIGS. 1A-1B, the battery pack 100 includes a housing 105 and at least one rechargeable battery cell 110 (shown in FIG. 1B) supported by the housing 105. The battery pack 100 also includes a support portion 115 for supporting the battery pack 100 on a tool, and a coupling mechanism 120 for selectively coupling the battery pack 100 to, or releasing the battery pack 100 from, the tool. The support portion 115 is connectable to a complementary support portion on the tool.

The battery pack 100 includes a plurality of terminals 125 located within the support portion 115 and operable to electrically connect the battery cells 110 to a PCB 130 within the battery pack 100. The plurality of terminals 125 includes, for example, a positive battery terminal, a ground terminal, and a sense or data terminal. The battery pack 100 is removably and interchangeably connected to a tool to provide operational power to the tool. The terminals 125 are configured to mate with corresponding power terminals extending from a tool within a complementary receiving portion or the tool.

The illustrated battery pack 100 includes ten battery cells 110. In other embodiments, the battery pack 100 can include additional or fewer battery cells 110. The battery cells can be arranged in series, parallel, or a series-parallel combination. For example, the battery pack can include a total of ten battery cells configured in a series-parallel arrangement of five sets of two series-connected cells. The series-parallel combination of battery cells allows for an increased voltage and an increased capacity of the battery pack. In some embodiments, the battery pack 100 includes five series-connected battery cells. In other embodiments, the battery pack 100 includes a different number of battery cells (e.g., between three and thirty battery cells) connected in series, parallel, or a series-parallel combination in order to produce a battery pack having a desired combination of nominal battery pack voltage and battery capacity.

The battery cells 110 are lithium-based battery cells having a chemistry of, for example, lithium-cobalt (“Li-Co”), lithium-manganese (“Li-Mn”), or Li-Mn spinel. In some embodiments, the battery cells 110 have other suitable lithium or lithium-based chemistries, such as a lithium-based chemistry that includes manganese, etc. The battery cells within the battery pack 100 provide operational power (e.g., voltage and current) to the tools. In one embodiment, each battery cell 110 has a nominal voltage of approximately 3.6V, such that the battery pack has a nominal voltage of approximately 18V. In other embodiments, the battery cells have different nominal voltages, such as, for example, between 3.6V and 4.2V, and the battery pack has a different nominal voltage, such as, for example, 10.8V, 12V, 14.4V, 24V, 28V, 36V, 60V, 80V, between 10.8V and 80V, etc. The battery cells 110 also each have a capacity of, for example, approximately between 1.0 ampere-hours (“Ah”) and 6.0Ah. In exemplary embodiments, the battery cells each have capacities of approximately, 1.5Ah, 2.4Ah, 3.0Ah, 4.0Ah, 6.0Ah, between 1.5Ah and 6.0Ah, etc. In some embodiments, a battery pack 100 having a total battery pack capacity of approximately 5.0Ah or greater (e.g., 5.0Ah to 12.0Ah) is used in combination with a vehicle battery jump starter. In other embodiments, a battery pack 100 having a total battery pack capacity of approximately 1.5Ah or greater (e.g., 1.5Ah to 12.0Ah) is used in combination with a vehicle battery jump starter.

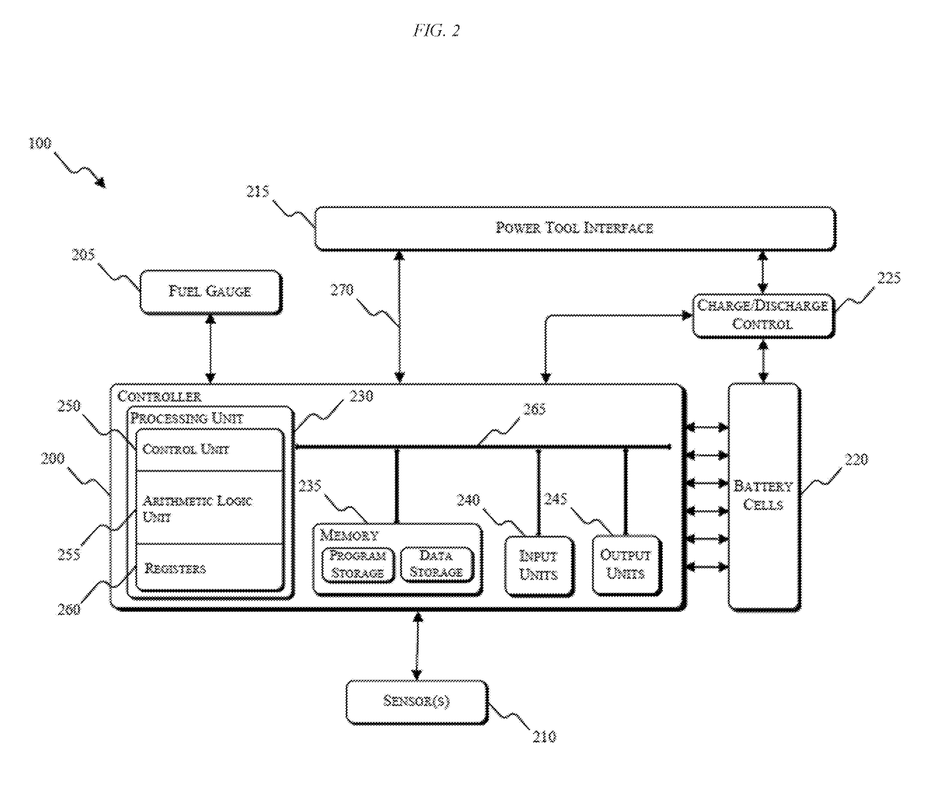

The power output by the battery pack 100 to a tool is controlled, monitored, and regulated using control electronics within the battery pack 100, a tool, or a combination thereof. FIG. 2 illustrates a controller 200 associated with the battery pack 100. The controller 200 is electrically and/or communicatively connected to a variety of modules or components of the battery pack 100. For example, the illustrated controller 200 is connected to a fuel gauge 205, one or more sensors 210, a tool interface 215, a plurality of battery cells 220, and a charge/discharge control module 225 (optional within battery pack). The controller 200 includes combinations of hardware and software that are operable to, among other things, control the operation of the battery pack 100, activate the fuel gauge 205, monitor the operation of the battery pack 100, etc. The fuel gauge 205 includes, for example, one or more indicators, such as light-emitting diodes (“LEDs”). The fuel gauge 205 can be configured to display conditions of, or information associated with, the state-of-charge of the battery cells 220. In some instances, information about the battery pack 100 is referred to as battery-specific information. The controller 200 also includes a variety of preset or calculated fault condition values related to temperatures, currents, voltages, etc., associated with the operation of a tool.

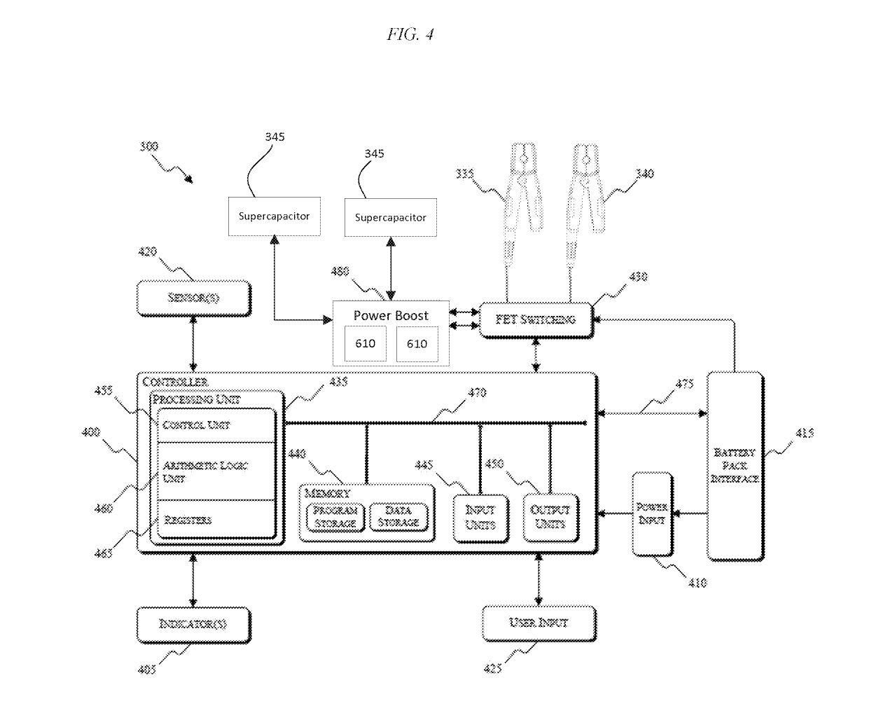

In some embodiments, the controller 200 includes a plurality of electrical and electronic components that provide power, operational control, and protection to the components and modules within the controller 200 and/or battery pack 100. For example, the controller 200 includes, among other things, a processing unit 230 (e.g., an electronic processor, a microprocessor, a microcontroller, or another suitable programmable device), a memory 235, input units 240, and output units 245. The processing unit 230 includes, among other things, a control unit 250, an arithmetic logic unit (“ALU”) 255, and a plurality of registers 260 (shown as a group of registers in FIG. 2), and is implemented using a known computer architecture, such as a modified Harvard architecture, a von Neumann architecture, etc. The processing unit 230, the memory 235, the input units 240, and the output units 245, as well as the various modules connected to the controller 200 are connected by one or more control and/or data buses (e.g., common bus 265). The control and/or data buses are shown generally in FIG. 4 for illustrative purposes. The use of one or more control and/or data buses for the interconnection between and communication among the various modules and components would be known to a person skilled in the art in view of the invention described herein. In some embodiments, the controller 200 is implemented partially or entirely on a semiconductor (e.g., a field-programmable gate array [“FPGA”] semiconductor) chip, such as a chip developed through a register transfer level (“RTL”) design process.

The memory 235 is a non-transitory computer readable medium that includes, for example, a program storage area and a data storage area. The program storage area and the data storage area can include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, or electronic memory devices. The processing unit 230 is connected to the memory 235 and executes software instructions that are capable of being stored in a RAM of the memory 235 (e.g., during execution), a ROM of the memory 235 (e.g., on a generally permanent basis), or another non-transitory computer readable medium such as another memory or a disc. Software included in the implementation of the battery pack 100 can be stored in the memory 235 of the controller 200. The software includes, for example, firmware, one or more applications, program data, filters, rules, one or more program modules, and other executable instructions. The controller 200 is configured to retrieve from memory and execute, among other things, instructions related to the control of the battery pack described herein. The controller 200 can also store various battery pack parameters and characteristics (including battery pack nominal voltage, chemistry, battery cell characteristics, maximum allowed discharge current, maximum allowed temperature, etc.). In other constructions, the controller 200 includes additional, fewer, or different components.

The tool interface 215 includes a combination of mechanical components (e.g., the support portion 115) and electrical components (e.g., the plurality of terminals 125) configured to, and operable for, interfacing (e.g., mechanically, electrically, and communicatively connecting) the battery pack 100 with a tool or another device. For example, power provided from the battery pack 100 to a tool or device is provided through the charge/discharge control module 225 to the tool interface 215. The charge/discharge control module 225 includes, for example, one or more switches (e.g., FETs) for controlling the charging current to and discharge current from the battery cells 220. In some embodiments, power provided from the battery pack 100 to a tool or device (or from a charger) is controlled by a charge/discharge control module 225 that is external to the battery pack 100 (i.e., internal to a tool, device, or charger). The tool interface 215 also includes, for example, a communication line 270 for providing a communication line or link between the controller 200 and a tool or device (e.g., a vehicle battery jump starter).

The sensors 210 include, for example, one or more current sensors, one or more voltage sensors, one or more temperature sensors, etc. For example, the controller 200 uses the sensors 210 to monitor an individual state of charge of each of the battery cells 220, monitor a current being discharged from the battery cells 220, monitor the temperature of one or more of the battery cells 220, etc. If the voltage of one of the battery cells 220 is equal to or above an upper voltage limit (e.g., a maximum charging voltage), the charge/discharge control module 225 prevents the battery cells from being further charged or requests that a battery charger (not shown) provide a constant voltage charging scheme. Alternatively, if one of the battery cells 220 falls below a low-voltage limit, the charge/discharge control module prevents the battery cells 220 from being further discharged. Similarly, if an upper or lower operational temperature limit for the battery cells 220 is reached, the controller 200 can prevent the battery pack 100 from being charged or discharged until the temperature of the battery cells 220 or the battery pack 100 is within an acceptable temperature range.

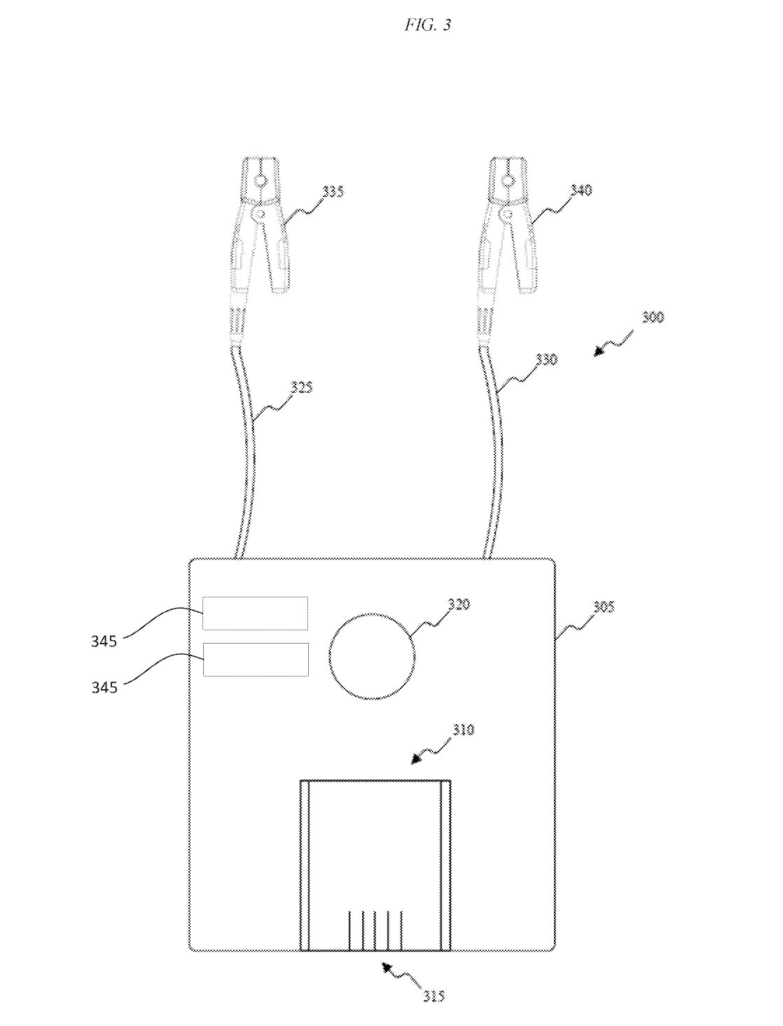

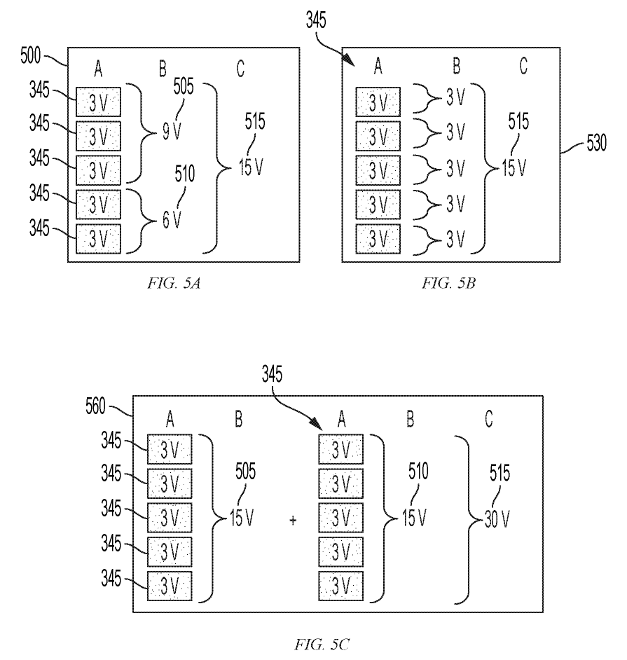

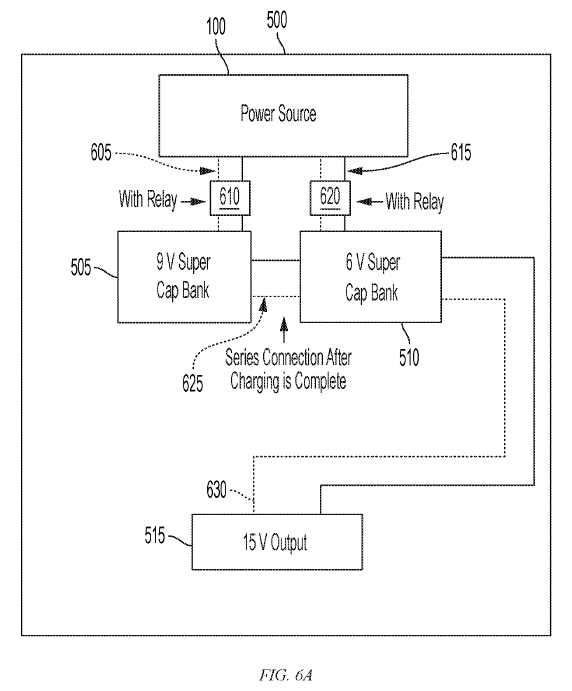

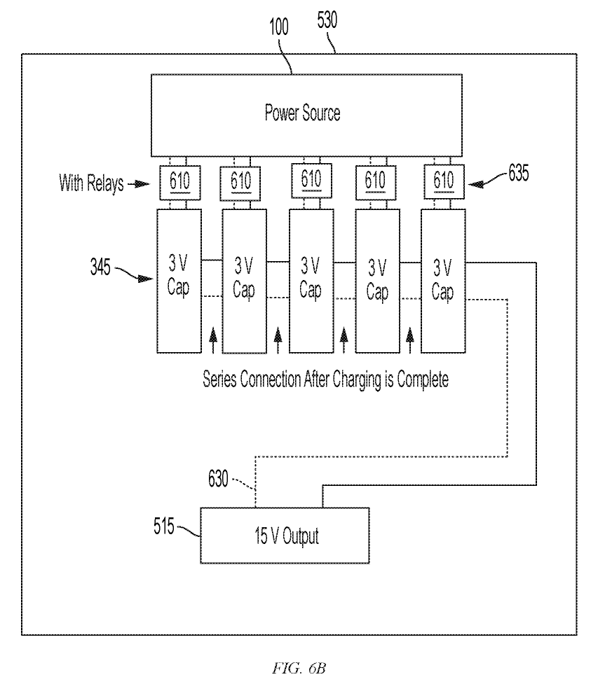

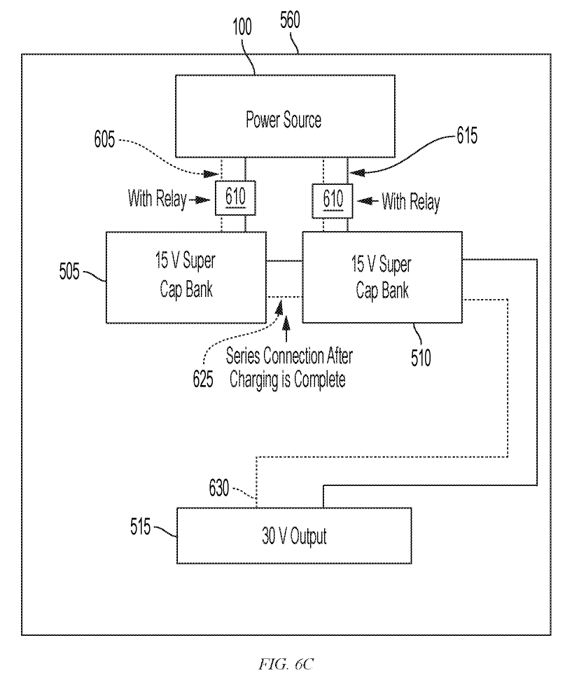

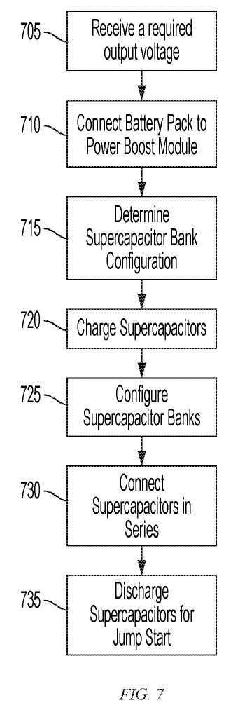

The battery pack 100 is connectable to and supportable by a vehicle battery jump starter such as vehicle battery jump starter 300 illustrated in FIG. 3. The vehicle battery jump starter 300 includes a housing 305, a support portion 310 for receiving and supporting the battery pack 100, a plurality of terminals 315 for electrically connecting the battery pack 100 to the vehicle battery jump starter 300, an ON or POWER button 320 for turning ON or activating the vehicle battery jump starter 300, a first electrical cable 325, a second electrical cable 330, a first terminal clamp 335, and a second terminal clamp 340. The first and second terminal clamps 335, 340 are coupled to the vehicle battery for jump starting the vehicle battery. The battery pack 100 connects to the vehicle battery jump starter 300 through the support portion 310 and the plurality of terminals 315. As a result, the battery pack 100 operates as a power source for the vehicle battery jump starter 300. The vehicle battery jump starter 300 also includes supercapacitors 345 and relays 610 as part of a power boost module 480. The battery pack 100 is used to charge the supercapacitors 345. Alternatively, the supercapacitors 345 may be charged via a connected vehicle battery (e.g., a vehicle battery connected to the vehicle battery jump starter 300 via the clamps 335, 340). The supercapacitors may be arranged into a single supercapacitor bank or separately arranged into multiple supercapacitor banks. The various aspects and arrangements of the supercapacitor banks are illustrated in FIGS. 5-6 and described in greater detail below.

The vehicle battery jump starter 300 includes a controller 400, as shown in FIG. 4. The controller 400 is electrically and/or communicatively connected to a variety of modules or components of the vehicle battery jump starter 300. For example, the illustrated controller 400 is connected to one or more indicators 405, a power input module 410, a battery pack interface 415, one or more sensors 420, a user input module 425, a FET switching module 430, and the power boost module 480. The battery pack interface 415 supplies power to the FET switching module 430 to be switched by the switching FETs to selectively provide power to charge the supercapacitors 345. The FET switching module 430 is also connected to the power boost module 480. In some examples, the power boost module 480 and the FET switching module 430 are combined into a single module. The controller 400 includes combinations of hardware and software that are operable to, among other things, control the operation of the vehicle battery jump starter 300, activate the one or more indicators 405 (e.g., an LED), monitor the operation of the vehicle battery jump starter 300, etc. The one or more sensors 420 include, among other things, one or more voltage sensors, one or more current sensors, one or more temperature sensors, etc.

In some embodiments, the controller 400 includes a plurality of electrical and electronic components that provide power, operational control, and protection to the components and modules within the controller 400 and/or vehicle battery jump starter. For example, the controller 400 includes, among other things, a processing unit 435 (e.g., a microprocessor, a microcontroller, or another suitable programmable device), a memory 440, input units 445, and output units 450. The processing unit 435 includes, among other things, a control unit 455, an ALU 460, and a plurality of registers 465 (shown as a group of registers in FIG. 4), and is implemented using a known computer architecture, such as a modified Harvard architecture, a von Neumann architecture, etc. The processing unit 435, the memory 440, the input units 445, and the output units 450, as well as the various modules connected to the controller 400 are connected by one or more control and/or data buses (e.g., common bus 470). The control and/or data buses are shown generally in FIG. 4 for illustrative purposes. The use of one or more control and/or data buses for the interconnection between and communication among the various modules and components would be known to a person skilled in the art in view of the invention described herein. In some embodiments, the controller 400 is implemented partially or entirely on a semiconductor (e.g., an FPGA semiconductor) chip.

The memory 440 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 435 is connected to the memory 440 and executes software instructions that are capable of being stored in a RAM of the memory 440 (e.g., during execution), a ROM of the memory 440 (e.g., on a generally permanent basis), or another non-transitory computer readable medium such as another memory or a disc. Software included in the implementation of the vehicle battery jump starter can be stored in the memory 440 of the controller 400. The software includes, for example, firmware, one or more applications, program data, filters, rules, one or more program modules, and other executable instructions. The controller 400 is configured to retrieve from memory and execute, among other things, instructions related to the control processes and methods described herein. In other constructions, the controller 400 includes additional, fewer, or different components.

The battery pack interface 415 includes a combination of mechanical components (e.g., the support portion 310) and electrical components (e.g., the plurality of terminals 315) configured to and operable for interfacing (e.g., mechanically, electrically, and communicatively connecting) the vehicle battery jump starter with the battery pack 100. For example, power provided by the battery pack 100 to the vehicle battery jump starter is provided through the battery pack interface 415 to a power input module 410. The power input module 410 includes combinations of active and passive components to regulate or control the power received from the battery pack 100 prior to power being provided to the controller 400. The battery pack interface 415 also includes, for example, a communication line 475 for providing a communication line or link between the controller 400 and the battery pack 100.

The power boost module 480 includes, for example, a plurality of supercapacitors 345 or lithium-polymer battery cells. The power boost module 480 is selectively charged by the controller 400 with power from the battery pack 100. In some embodiments, the power boost module 480 is charged by a vehicle battery (e.g., supercapacitors can be charged from a vehicle battery). The power boost module 480 can be used in conjunction with the battery pack 100 to provide power to a vehicle battery to jump start the vehicle battery. In some embodiments, the power boost module 480 and supercapacitors 345 alone (i.e., without battery pack 100) provide the current used to jump start a vehicle battery. The controller 400 is configured to control the arrangement of the supercapacitors 345 into one or more supercapacitor banks. The arrangement of the supercapacitor banks are illustrated in FIGS. 5A-5C and 6A-6C. In some examples, the power boost module 480 controls the arrangement of the supercapacitors 345 into multiple supercapacitor banks. In some examples, the power boost module 480 works in conjunction with the charge control circuit 275 to charge the supercapacitors 345 arranged in multiple supercapacitor banks.

In some embodiments, the vehicle battery jump starter 300 may include optimization features configured to be implemented by a charge control circuit 275. For example, before current is discharged from the battery pack 100, the charge control circuit 275 measures one or more parameters of the battery pack 100. In one embodiment, the parameter is a no-load voltage of the battery pack 100, which may be determined using, for example, the sensor 210. The measured battery pack voltage is then used by the charge control circuit 275 to calculate an allowable load voltage (also referred to as a threshold or a predetermined threshold) for the battery pack 100 when being discharged by the charge control circuit 275. In some examples the allowable load voltage is a predetermined voltage level.

In response to the allowable load being determined, the charge control circuit 275 then controls the vehicle battery jump starter 300 to draw current from the battery pack 100 until the allowable load level is reached. In some examples, the load level is determined based on a voltage drop during discharge. The charge control circuit 275 may prevent the vehicle battery jump starter 300 from drawing a current that would cause an undesired drop in voltage of the battery pack 100, e.g., below the load voltage threshold. For example, when charging multiple supercapacitors simultaneously, an increased load may be placed onto the battery pack 100. In some embodiments, the charge control circuit 275 continues to measure the voltage of the battery pack 100 during discharge and modulates the discharge current in order to maintain the battery voltage at or above the allowable load voltage threshold. In some embodiments, the functions of the charge control circuit 275 are performed by the controller 400.

In some instances, the charge control circuit 275 may calculate the allowable load voltage threshold, or control the discharging of the battery pack 100, based upon the type of battery pack 100 connected. For example, when a low performing battery (e.g., a battery with high impedance) is connected to the vehicle battery jump starter 300, the allowable voltage threshold may be reached with a lower overall discharge current. On the other hand, when a high performing battery (e.g., a battery with low impedance) is connected to the vehicle battery jump starter 300, the allowable voltage threshold may be reached with a higher overall discharge current. In other words, a low performing battery pack may produce an overall lower discharge current, and therefore a longer charging time, than a high performing battery pack.

The charge control circuit 275 is configured to control the vehicle battery jump starter 300 in order to maximize the efficiency of the battery pack 100, regardless of its performance level. In some examples, battery information, such as impedance, capacity, state of health, state of charge, temperature, etc., may be communicated by the battery controller 200 to the vehicle battery jump starter 300. In other examples, the battery information may be determined by the controller 400 and/or charge control circuit 275 upon the battery pack 100 being electrically coupled to the vehicle battery jump starter 300. In some examples, the user is notified of the type of battery connected to the vehicle battery jump starter 300.

In some embodiments, the vehicle battery jump starter 300 may communicate with the controller 200 of the battery pack to obtain battery specific information. The battery specific information may be, for example, a battery capacity level, an impedance level, a battery age, a battery temperature, a battery voltage level, or historical data such as a number of battery charge/discharge cycles, number of battery usages, or a number of battery overtemperature events. Once the battery specific information is obtained by the controller 400, the charge control circuit 275 may use some or all of the battery specific information to calculate an appropriate discharge current. For instance, as previously described, high/low performing batteries may have different impedance levels. The charge control circuit 275 may calculate the appropriate discharge current (and therefore the predetermined load voltage level) based upon the battery specific impedance level obtained from the battery pack 100. The battery specific information and discharge current may also be used by the controller 400 to determine the configuration of the multiple supercapacitor banks.

In some embodiments, the vehicle battery jump starter 300 is configured to monitor characteristics of the battery pack 100 during operation. For example, the charge control circuit 275 is configured to monitor discharge characteristics of the battery pack 100 during operation of the vehicle battery jump starter 300 in order to predict behavior. In other words, the monitored characteristics are used by the charge control circuit 275 to determine optimal discharge rates for the battery pack 100. This prediction may also be used to determine whether the selected battery pack is a high- or low-performance battery (e.g., high or low impedance battery). Additionally, the charge control circuit 275 may use the predicted behavior to modulate the discharge rate of the battery pack 100. In some instances, the prediction utilizes machine learning to create a prediction profile for the battery pack 100. The prediction profile may contain historical data from previous uses of the battery pack 100 and is used by the charge control circuit 275 to determine the capabilities of the battery pack (e.g., the optimal discharge rates, the allowable voltage threshold, and the like). In some examples, the power input module 410 is configured to perform all of the functions of the charge control circuit 275.

In some embodiments, the vehicle battery jump starter 300 is configured to monitor the voltage level of the battery pack 100, as previously described, and adjusts the performance of elements within the vehicle battery jump starter 300 based upon the voltage of the battery pack 100 during discharge. For example, in response to the monitored voltage of the battery pack 100 being below the allowable voltage threshold, as previously described, the controller 400 may reduce power draw, extend a run time, modify performance of the power boost module 480, and/or perform other operations as required for a given application.

FIGS. 5A-5C illustrate a number of configurations of the supercapacitors 345 divided into multiple supercapacitor banks. In a first configuration 500, as illustrated in FIG. 5A, supercapacitors 345 are arranged independent (A) form a supercapacitor bank. Each of the supercapacitors 345 has an individual voltage (e.g., 3 Volts) and is charged by the controller 400 using energy from the battery pack 100, as previously described. Once the supercapacitors are charged, the controller 400 combines multiples of the supercapacitors into one or more supercapacitor banks (B). For example, the controller 400 may combine three of the supercapacitors 345 in series into a first supercapacitor bank 505 having a first voltage. The controller 400 may also combine two of the supercapacitors 345 in series into a second supercapacitor bank 510 having a second voltage. In the first configuration 500, the first supercapacitor bank 505 and the second supercapacitor bank 510 have two separate total voltages (e.g., 9 Volts and 6 Volts). In alternative examples, the first and second supercapacitor banks 505, 510 may have the same voltage (e.g., both6 Volts or both 9 Volts).

Once the first and second supercapacitor banks 505, 510 are combined by the controller 400, the controller 400 may further combine the supercapacitor banks 505, 510 in series to generate a final output voltage 515. The final output voltage 515 has a total voltage that is equal to the series combination of voltages for each of the supercapacitors 345 that contribute to the multiple supercapacitor banks. In this way, the maximum voltage output may total to a voltage level that is greater than the voltage of the battery pack 100 without boosting a voltage of the battery pack 100. For example, if the battery pack 100 voltage level is approximately 12 Volts, the controller may charge five separate supercapacitors 345 each to 3 Volts using the energy from the battery pack 100.

Once the supercapacitors 345 are charged, the controller 400 may combine the supercapacitors 345 in series, as described with respect to the first configuration 500, to obtain a voltage level of 15 Volts. The first configuration 500 also provides a total output voltage level that is greater than the total voltage level of the battery pack 100 without the need of a boost or step up converter circuit. In some examples, the supercapacitors 345 may be combined into supercapacitor banks 505, 510 before they are charged.

The total voltage of the combined supercapacitor banks 505, 510 depends upon the number of supercapacitors 345 that are combined by the controller 400 to form the bank 505, 510. In a second configuration 530, as illustrated in FIG. 5B, five separate supercapacitors 345 are combined in series, by the controller 40, into a final supercapacitor bank without an intermediate step of separately combining the supercapacitors 345 into the first and second supercapacitor banks 505, 510. In the second configuration 530, each of the supercapacitors 345 is charged by the controller 400 using energy from the battery pack 100 (A). Once the individual supercapacitors 345 are charged they are combined in series into an output voltage 515 having a voltage that is equal to the total series voltage of the supercapacitors 345 (e.g.,15 Volts).

In a third configuration 560, as illustrated in FIG. 5C, the first supercapacitor bank 505 is a combination of five supercapacitors 345 and the second supercapacitor bank 510 is a combination of another five supercapacitors 345. The third configuration 560 first and second supercapacitor banks 505, 510 are both equal in voltage to the final output voltage 515 of each of the first and second configuration 500, 530. Similar to the previous combinations, in the third configuration 560, the controller 400 then combines the first and second supercapacitor banks 505, 510 into a final output voltage 515 having a voltage that is equal to the series combination of the first and second supercapacitor banks 505, 510. In this configuration, the final output voltage 515 is approximately ten times greater than the voltage of an individual supercapacitor 345. In this way the vehicle battery jump starter 300 is able to obtain a voltage output level that is much greater than the voltage level of the battery pack 100 that is used to charge the supercapacitors 345 without the use of a boost circuit or any step-up voltage converters.

In some examples, the greater output voltage provided by the third configuration may be used to jump start vehicle batteries that are unconventionally large or greater than a traditional passenger vehicle battery. For instance, a large commercial vehicle may have a vehicle battery that is rated for 24 Volts. A jump start device having an output voltage of only 12 to 15 Volts would not be able to provide the necessary current to jump start the 24 Volt vehicle battery. Such a problem is solved by using a vehicle battery jump starter 300 with the third configuration 560, namely one having an output voltage that is approximately 30Volts.

In some examples, the vehicle battery jump starter 300 may include a selector switch or other user selectable input device (e.g., user input module 425) that enables a user to select the desired output voltage level. Once a selection is made, the controller 400 then controls the combination of supercapacitors 345 into variously sized supercapacitor banks 505, 510, to output the desired voltage level. In some examples, some of the supercapacitor banks may be configured in parallel to provide a greater current output. In previous examples, two supercapacitor banks 505, 510 were configured in series. As an alternative, the supercapacitor banks 505, 510 may be configured in parallel. For instance, two supercapacitor banks 505, 510 each totaling 15 Volts may be electrically connected in parallel to total an output voltage of 15 Volts with a greater current potential than only one 15 Volt supercapacitor bank.

FIGS. 6A-6C illustrate additional components of the various configurations of supercapacitors into supercapacitor banks. As shown in FIG. 6A, the first configuration 500 includes the battery pack 100 connected to the first supercapacitor bank 505 via a first electrical connection 605. The connection 605 includes a relay 610 (or, as illustrated, multiple relays) controlled by the controller 400. The relay 610 enables the controller 400 to configure the supercapacitors 345 into the first supercapacitor bank 505 or to charge the supercapacitors 345 from the battery pack 100. For example, the controller may actuate the one or more relay 610 to connect individual supercapacitors 345 to be charged from the battery pack 100 at predetermined voltage levels. Once the supercapacitors 345 are charged, the relays 610 reconfigure the connections by grouping a first selection of the charged supercapacitors into a first supercapacitor bank 505 and a second selection into a second supercapacitor bank 510. In the first configuration 500, the first supercapacitor bank 505 is charged to a higher predetermined voltage relative to the second supercapacitor bank 510, which is charged to a lower voltage. Subsequently, the relays 610 enable the controller to electrically combine these supercapacitor banks 505, 510 in series, resulting in a final output voltage that exceeds the voltage of the removable and rechargeable battery pack and is capable of delivering the necessary jump start current to a vehicle battery.

In some examples, the relay 610 additionally or alternatively enables the controller 400 to charge the first supercapacitor bank 505 after the supercapacitors 345 are combined. The first configuration 500 also includes a second electrical connection 615 that connects to the second supercapacitor bank 510. The second connection 615 also includes a relay 610. As previously described, once the supercapacitor banks 505, 510 are fully charged, they are connected in series via a third electrical connection 625. The series connected supercapacitor banks are then provided to the final output voltage 515 via a fourth electrical connection 630.

FIG. 6B similarly illustrates the second configuration 530, including the connection between the supercapacitors 345 and the battery pack 100 via a plurality of electrical connections 635. Each of the plurality of electrical connections 635 connects one of the supercapacitors 345 to the battery pack 100 through a relay 610. Once the supercapacitors 345 are charged, they are connected in series as previously described. The series connected supercapacitors 345 then provide the final output voltage 515 via the fourth electrical connection 630. FIG. 6C further illustrates the third configuration 560. Similar to the first configuration 500, the third configuration 560 includes a first electrical connection 605 having a relay 610 connected to the first supercapacitor bank 505 and a second electrical connection 615 with a relay 610 connected to the second capacitor bank 510. In response to the first and second supercapacitor banks 505, 510 being charged, they are connected in series via the third electrical connection 625 and the final output voltage 515 is provided via the fourth electrical connection 630.

FIGS. 5A-5C and 6A-6C illustrate three of the possible supercapacitor configurations. However, additional configurations of supercapacitors are available. For example, three groups of two supercapacitors 345 may be combined into three supercapacitor banks, each having a voltage level of 6 Volts and a final voltage output level of 18 Volts. In another example, two9 Volt supercapacitor banks (e.g., three 3 Volt super capacitors in series) may be combined in parallel and two 6 Volt supercapacitor banks (e.g., two 3 Volt super capacitors in series) may be combined in parallel, with the two 9 Volt supercapacitor banks and the two 6 Volt supercapacitor banks further combined in series. This configuration would have a final output voltage level of 15 Volts with twice the possible current provided as the first configuration, detailed in FIG. 5A and 6A. Additional combinations of supercapacitors 345 may achieve alternative final output voltage levels ranging anywhere from 12 Volts to 30 Volts, or greater, depending on the total number of supercapacitors 345 within the vehicle battery jump starter 300. In some examples, the final output voltage exceeds the voltage of the battery pack by a factor of 1.5, 2, or more.

As previously described, the vehicle battery jump starter 300 may include a user selectable input enabling the user to set a desired final output voltage level. In some instances, the final output voltage level is instead automatically selected by the controller 400 upon the vehicle battery jump starter 300 being attached to the vehicle battery. For example, the vehicle battery jump starter 300 may be configured to measure and/or determine a voltage level of the vehicle battery (e.g., via one or more sensors 420) when the clamps 335, 340 are connected. Once the controller 400 determines the vehicle battery voltage level, the controller 400 may automatically select a configuration of supercapacitors 345 to combine in series in order to obtain the final voltage output level required to jump start the vehicle battery. In some instances, the vehicle battery jump starter 300 may notify the user of the configuration via one of the indicators 405.

FIG. 7 is a flow chart illustrating a process 700 for operating the combination of battery pack 100 and vehicle battery jump starter 300. The process 700 begins with the battery pack 100 being attached to the vehicle battery jump starter 300 and the required voltage output being selected (e.g., the final output voltage level), at process block 705. As previously described, the required voltage output may be selected by a user via a switch or other input or may be automatically selected by the controller 400. The controller 400 then connects the power boost module 480, which includes the supercapacitors 345, to the battery pack 100 for charging, at process block 710. At process block 715, the controller 400 determines the configuration of supercapacitor banks 505, 510 to achieve the final output voltage 515 as desired.

The controller 400 then charges the supercapacitors 345 using energy from the battery pack 100 at process block 720 and arranges the supercapacitors 345 into the required configuration of supercapacitor banks 505, 510. As previously described, any of process blocks 715 through process block 725 may be performed in any order. For example, the supercapacitors may be configured into supercapacitor banks 505, 510 (process block 725) before or after being charged (process block 720). Once the supercapacitor banks 505, 510 are configured, the controller 400 connects the supercapacitor banks in the required electrical connection (e.g., series, parallel, or both), at process block 730. With the supercapacitor banks 505, 510 in series, the vehicle battery jump starter 300 is ready to discharge the final output voltage 515 into a vehicle battery to jump start the vehicle battery, at process block 735.

Thus, the invention provides, among other things, a vehicle battery jump starter powered by a removable and rechargeable battery pack.

What is claimed:

1. A vehicle battery jump starter device comprising:
a battery pack interface configured to receive a removable and rechargeable battery pack;
a power boost module including a plurality of supercapacitor banks, each supercapacitor bank comprising a plurality of supercapacitors, the power boost module configured to be charged via the battery pack interface from the removable and rechargeable battery pack; and
a controller including an electronic processor configured to:
selectively charge the plurality of supercapacitors to predetermined voltage levels,
combine a selection of supercapacitor banks in series to produce a final output voltage that exceeds the voltage of the battery pack, and
control a discharge current from the series-combined supercapacitor banks to deliver a jump start current to a vehicle battery.

2. The vehicle battery jump starter device of claim 1, further comprising a user selectable input configured to enable a user to select a desired final output voltage level.

3. The vehicle battery jump starter device of claim 1, wherein the battery pack interface comprises a plurality of electrical terminals configured to couple mechanically and electrically with the removable and rechargeable battery pack.

4. The vehicle battery jump starter device of claim 1, further comprising one or more relays operatively coupled to the controller and configured to selectively configure the plurality of supercapacitors into the supercapacitor banks.

5. The vehicle battery jump starter device of claim 1, wherein the controller is further configured to automatically determine a configuration of the supercapacitor banks based on one or more parameters of a connected vehicle battery; and
combine the selected charged supercapacitor banks in series to produce the final output voltage.

6. The vehicle battery jump starter device of claim 1, wherein the controller is further configured to monitor at least one condition of the removable and rechargeable battery pack, the condition comprising at least one of a voltage, a temperature, or an impedance, and to adjust the charging of the supercapacitors based upon the at least one condition.

7. The vehicle battery jump starter device of claim 1, wherein the power boost module comprises:
a first plurality of supercapacitors combined in series to form a first supercapacitor bank, and a second plurality of supercapacitors combined in series to form a second supercapacitor bank,
wherein the first and second supercapacitor banks are further connected in series, by the controller, to generate the final output voltage.

8. The vehicle battery jump starter device of claim 1, wherein the final output voltage produced by the series-combined supercapacitor banks exceeds the voltage of the battery pack by a factor of at least 1.5.

9. The vehicle battery jump starter device of claim 1, further comprising a FET switching module operatively coupled to the controller and configured to control both charging and discharging operations of the plurality of supercapacitor banks.

10. The vehicle battery jump starter device of claim 1, further comprising a communication interface configured to transmit battery-specific information between the removable and rechargeable battery pack and the controller.

11. The vehicle battery jump starter device of claim 1, wherein the controller further comprises a memory for storing historical performance data of the removable and rechargeable battery pack, and wherein the stored historical performance data is used to adjust charging and discharge parameters of the power boost module.

12. A vehicle battery jump starter device comprising:
a battery pack interface configured to receive a removable and rechargeable battery pack, the removable and rechargeable battery pack having a voltage;
a power boost module including a plurality of supercapacitors, and
a controller including an electronic processor configured to:
charge the plurality of supercapacitors from energy provided from the removable and rechargeable battery pack;
configure a first selection of the plurality of supercapacitors into a first supercapacitor bank, the first supercapacitor bank configured to be charged to a predetermined voltage level that is less than the voltage of the battery pack,
configure a second selection of the plurality of supercapacitors into a second supercapacitor bank, the second supercapacitor bank configured to be charged to a predetermined voltage level that is less than the voltage of the battery pack and less than the voltage of the first supercapacitor bank,
combine the first supercapacitor bank and the second supercapacitor bank in series to produce a final output voltage, the final output voltage being greater than the voltage of the removable and rechargeable battery pack, and
control a discharge current from the series-combined supercapacitor banks to deliver a jump start current to a vehicle battery.

13. The vehicle battery jump starter device of claim 12, further comprising a user selectable input device configured to enable a user to select a desired final output voltage prior to the configuration of the first and second supercapacitor banks.

14. The vehicle battery jump starter device of claim 12, wherein the controller is further configured to monitor the voltage of the removable and rechargeable battery pack and adjust the charging of the plurality of supercapacitors based on the monitored voltage.

15. The vehicle battery jump starter device of claim 12, further comprising one or more relays operatively coupled to the controller and configured to selectively connect the plurality of supercapacitors to the removable and rechargeable battery pack.

16. The vehicle battery jump starter device of claim 12, wherein the controller is further configured to automatically determine a number of supercapacitors in the plurality of supercapacitors to include in the first supercapacitor bank and the second supercapacitor bank based on a measured voltage of a connected vehicle battery.

17. A method for operating a vehicle battery jump starter device, the method comprising:
attaching a removable and rechargeable battery pack, the battery pack having a voltage, to the vehicle battery jump starter device via a battery pack interface;
selecting a required final output voltage level for the vehicle battery jump starter device;
connecting a power boost module, the power boost module including a plurality of supercapacitors, to the battery pack for charging the plurality of supercapacitors from energy provided by the battery pack;
determining, via a controller including an electronic processor, a configuration of supercapacitor banks by:
connecting a first selection of the plurality of supercapacitors into a first supercapacitor bank configured to be charged to a predetermined voltage level that is less than the voltage of the battery pack, and
connecting a second selection of the plurality of supercapacitors into a second supercapacitor bank configured to be charged to a predetermined voltage level that is less than both the voltage of the battery pack and the voltage of the first supercapacitor bank;
charging and connecting the plurality of supercapacitors into the determined configuration of the first and second supercapacitor banks;
combining the first and second supercapacitor banks in series to produce a final output voltage that exceeds the voltage of the removable and rechargeable battery pack; and
controlling a discharge current from the series-combined supercapacitor banks to deliver a jump start current to a vehicle battery.

18. The method of claim 17, further comprising receiving a user input via a user selectable input device to determine the required final output voltage level.

19. The method of claim 17, further comprising monitoring at least one parameter of the removable and rechargeable battery pack, the parameter selected from the group consisting of voltage, temperature, and impedance, and adjusting the charging of the plurality of supercapacitors based on the monitored parameter.

20. The method of claim 17, further comprising automatically determining, via the controller, a configuration of the plurality of supercapacitors into the first and second supercapacitor banks based on battery-specific information of the removable and rechargeable battery pack.
